(19) United States
(12) Patent Application Publication
(10) Pub. No.: US 2022/0009057 A1
(43) Pub. Date: Jan. 13, 2022

(54) BIFURCATED LOCKING PLIERS FOR ENHANCED CONTROL OF ADEL CLAMPS DURING INSTALLATION, INSPECTION, AND REMOVAL

(71) Applicant: Gary Kevin Beulah, Riverdale, GA (US)

(72) Inventor: Gary Kevin Beulah, Riverdale, GA (US)

(21) Appl. No.: 16/924,753

(22) Filed: Jul. 9, 2020

(51) Int. Cl. B25B 7/06; B25B 7/14

(52) U.S. Cl. CPC B25B 7/06; B25B 7/14

(57) ABSTRACT

A locking pliers for enhanced control of Adel clamps during installation, inspection, and removal of Adel clamps. The locking pliers is made from high-carbon steel, and includes a first plier arm having a first bifurcated grasping portion, a first pivot portion, and a first handle portion ending in a series of ridges. The locking pliers also includes a second plier arm having a second bifurcated grasping portion, a second pivot portion pivotably connected to the first pivot portion, and a second handle portion ending in a wedge that is cooperative with the series of ridges serving as an adjustable locking mechanism. The handle portion includes cushioning grip material. The locking pliers also include a leaf spring to resiliently resist bringing the two handle portions together. In some embodiments, each bifurcated grasping portion includes a slot of a width to partially surround a screw and a hole that accepts the screw.

### FIELD OF THE INVENTION

This invention relates generally to pliers, and more particularly to locking pliers.

### BACKGROUND OF THE INVENTION

The wires that run through an aircraft and engine compartment need to be secured into bundles to prevent interfering with moving parts or chafing. Adel Clamps, also known as MS21919 aircraft clamps, are key components used in line support, vibration dampening, and maintaining proper clearance for lines or wire harnesses running throughout the aircraft structure. An Adel Clamp is a metal band made from aluminum, corrosion-resistant steel, and low-carbon steel, covered by a rubber lining or cushion made from silicone.

A visual inspection, no matter how trivial, needs to include an inspection of these clamps to determine whether they need to be replaced. The lining or cushions of the clamps are exposed to heat, vibration, ozone, and a variety of petroleum-based and synthetic-based fluids. Over the years, inspections have found cushions torn or missing, thereby exposing the metal bands. These clamps should be replaced.

When a careful examination of an Adel clamp reveals that the cushion has worn away on the inside of the band, possibly creating a bare-band-to-line or -wire condition, the clamp should be replaced.

When an Adel clamp fails in these ways, it has been observed in fuel systems to cause non-designed fuel migration, or a low fuel pressure situation. In hydraulic lines, Adel clamp bands have been found rubbing through hydraulic system lines, resulting in a loss of hydraulic quantity. Intermittent electrical faults have led technicians to find an Adel clamp cutting into an electrical harness.

The MS21919 aircraft clamp has been used safely by many aircraft OEMs with very little trouble. However, a skilled technician must look closely at these clamps to verify that they are in good condition, and further knows that their replacement is not easy, but is necessary. The cost to repair the many systems they support vastly outweighs the cost of replacing the clamps as simple preventive maintenance.

### SUMMARY OF THE INVENTION

The bifurcated locking pliers of the invention are very useful for working with wire harnesses in the aircraft industry. The bifurcated locking pliers are particularly good for easy installation, inspection, and removal of Adel clamps that are used to secure wire harnesses, hydraulic lines, fuel lines, pneumatic lines, and other aerospace/aviation related systems. To use the bifurcated locking pliers, simply position an Adel clamp and compress it using the bifurcated locking pliers. Then, affix the hardware using a fastener. Next, remove the bifurcated locking pliers, and tighten the fastener until secure.

A general aspect of the invention is a locking pliers for enhanced control of Adel clamps during installation, inspection, and removal of such clamps. The locking pliers includes: a first plier arm having a first bifurcated grasping portion, a first pivot portion, a first handle portion extending from the first pivot portion, the first handle portion ending in a series of ridges; and a second plier arm having a second bifurcated grasping portion, a second pivot portion pivotably connected to the first pivot portion, a second handle portion extending from the second pivot portion, the second handle portion ending in a wedge, the wedge being cooperative with the series of ridges so as to serve as an adjustable locking mechanism.

In some embodiments, the handle portions are coated with cushioning grip material.

In some embodiments, the cushioning grip material is made from rubber or silicone.

In some embodiments, the first and second bifurcated grasping surfaces have smoothed edges.

In some embodiments, the locking pliers further includes a leaf spring configured to resiliently resist bringing the first handle portion and the second handle portion together.

In some embodiments, the first plier arm and the second plier arm are made from high-carbon steel.

In some embodiments, the first plier arm and the second plier arm are of equal length, the length being within a range of: 8″ to 12″.

In some embodiments, the first bifurcated grasping portion and the second bifurcated grasping portion exhibit mirror symmetry.

In some embodiments, each bifurcated grasping portion includes a slot having a width configured to accommodate a screw.

In some embodiments, the first handle portion has an arcuate shape, and the second handle portion has an arcuate shape.

Another aspect of the invention is a locking pliers for enhanced control of Adel clamps during installation, inspection, and removal of such clamps. These locking pliers include: a first plier arm having a first bifurcated grasping portion having a slot of a width configured to accommodate a screw, a first pivot portion, a first handle portion extending from the first pivot portion, the first handle portion ending in a series of ridges, the first handle portion coated with cushioning grip material; a second plier arm having a second bifurcated grasping portion having a slot of a width configured to accommodate a screw, a second pivot portion pivotably connected to the first pivot portion, a second handle portion extending from the second pivot portion, the second handle portion ending in a wedge, the wedge being cooperative with the series of ridges so as to serve as an adjustable locking mechanism, the second handle portion coated with cushioning grip material; and a leaf spring configured to resiliently resist bringing the first handle portion and the second handle portion together.

In some embodiments, the cushioning grip material is made from rubber or silicone.

In some embodiments, the first and second bifurcated grasping surfaces have smoothed edges.

In some embodiments, the first plier arm and the second plier arm are made from high-carbon steel.

In some embodiments, the first plier arm and the second plier arm are of equal length, the length being within a range of: 8″ to 12″.

In some embodiments, the first bifurcated grasping portion and the second bifurcated grasping portion exhibit mirror symmetry.

In some embodiments, the first handle portion has an arcuate shape, and the second handle portion has an arcuate shape.

### BRIEF DESCRIPTION OF THE DRAWINGS

Many additional features and advantages will become apparent to those skilled in the art upon reading the following description, when considered in conjunction with the accompanying drawings, wherein:

FIG. 1 is a perspective view of an embodiment of the bifurcated locking pliers in an open configuration, and not locked.

FIG. 2 is an exploded view of the bifurcated locking pliers of FIG. 1.

FIG. 3 is a perspective view of the bifurcated locking pliers of FIG. 1 in an open configuration, positioned so as to be ready to compress an Adel clamp.

FIG. 4 is a side view of the bifurcated locking pliers of FIG. 3 in an open configuration, positioned so as to be ready to compress the Adel clamp of FIG. 3.

FIG. 5 is a side view of the bifurcated locking pliers of FIG. 4 in a closed and locked configuration so as to maintain the Adel clamp of FIG. 3 in a compressed configuration.

FIG. 6 is a rear view of the locking mechanism of the bifurcated locking pliers of FIG. 5, the locking mechanism being a wedged projection at the end of one of the handles that can be captured in one of a series of ridges along the end of the opposing handle of the locking pliers.

FIG. 7 is a top view of the bifurcated grasping portion of the locking pliers of FIG. 5 shown in a closed configuration for maintaining an Adel clamp compressed around a generic cylindrical object, the Adel clamp having a screw hole and the bifurcated grasping portion providing access to the screw hole while the Adel clamp is compressed by the bifurcated grasping portion.

FIG. 8 is a side view of the locking pliers of FIG. 7 shown in a closed configuration for maintaining the Adel clamp compressed around the generic cylindrical object, the screw hole of the Adel clamp about to receive a screw while the bifurcated grasping portion maintains the Adel clamp in a compressed configuration.

FIG. 9 is a side view of the locking pliers of FIG. 8 shown in a closed configuration and maintaining the Adel clamp compressed around the generic cylindrical object while the screw is fully inserted into the screw hole of the Adel clamp so as to secure the Adel clamp in a compressed configuration.

FIG. 10 is a side view of the locking pliers of FIG. 8 shown in an open position and free to move away after the screw has secured the Adel clamp in the compressed configuration around the generic cylindrical object.

FIG. 11 is a side view of the bifurcated locking pliers of FIG. 4 in a closed and locked configuration, the bifurcated grasping portion of the pliers shown without an Adel clamp, showing some exemplary dimensions of various portions of the bifurcated locking pliers.

FIG. 12 is a top view of the bifurcated locking pliers of FIG. 11 showing some exemplary dimensions of various portions of the bifurcated locking pliers.

### DETAILED DESCRIPTION

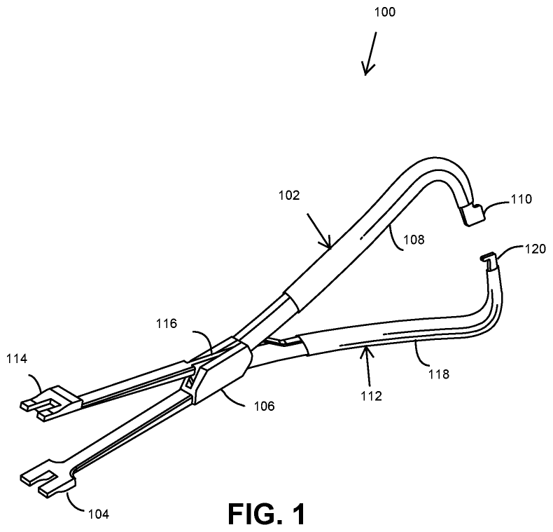

With reference to FIG. 1, an embodiment 100 of the bifurcated locking pliers is shown in an open unlocked configuration. A first plier arm 102 includes a first bifurcated grasping portion 104, a first pivot portion 106, and a first handle portion 108 having a series of ridges 110 located at the end of the first plier arm 102.

Also, a second plier arm 112 includes a second bifurcated grasping portion 114, a second pivot portion 116, and a second handle portion 118 having a wedge 120 for engaging with the series of ridges 110, the wedge 120 being located at the end of the second plier arm 112. The wedge 120 works cooperatively with the series of ridges 110 as an adjustable locking mechanism.

As the pliers 100 are closed, the bifurcated grasping surfaces 104 and 114 move towards each other, while the wedge 120 engages with one pair of ridges of the series of ridges (two or more ridges) 110 at the end of the first handle 108, thereby keeping the bifurcated grasping surfaces 104 and 114 from separating. If there are three ridges, there are two possible locations for the wedge 120 to engage. If there are four ridges, there are three possible locations for the wedge 120 to engage, each location representing a different degree of compression. The first pair of ridges facilitates a first amount of compression of the first bifurcated grasping portion 104 towards the second bifurcated grasping portion 114. If the user further presses the first handle portion 108 towards the second handle portion 118, the wedge 120 will move beyond the first and second ridges to settle between the second and third ridges, thereby locking the pliers 100 closed with greater compression of the first bifurcated grasping portion 104 towards the second bifurcated grasping portion 114.

Thus, it is possible to select an amount of compression applied by the pliers 100 by simply moving the wedge 120 along the ridges 110 until a desired amount of compression is achieved.

To release the compression, the user simply pushes the wedge 120 perpendicularly away from (rather than along) the ridges 110 so as to disengage the wedge 120 from the ridges 110, thereby allowing the bifurcated grasping portions 104 and 114 to move apart.

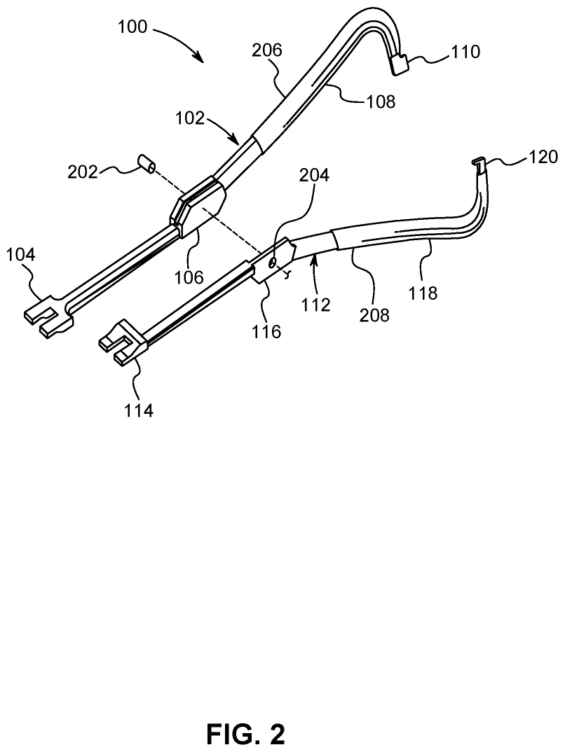

With reference to FIG. 2, an exploded view of the bifurcated locking pliers 100 is shown. The first plier arm 102 is pivotably attached to the second plier arm 112 via the pivot pin 202 which extends through a hole (not shown) in the first pivot portion 106, and through a hole 204 the second pivot portion 116.

Note that the first handle portion 108 and the second handle portion 118 are coated with cushioning grip material 206 and 208, respectively. The cushioning grip material 206 and 208 can be either rubber or silicone, or any material that adds cushioning to the handle portions 108 and 118.

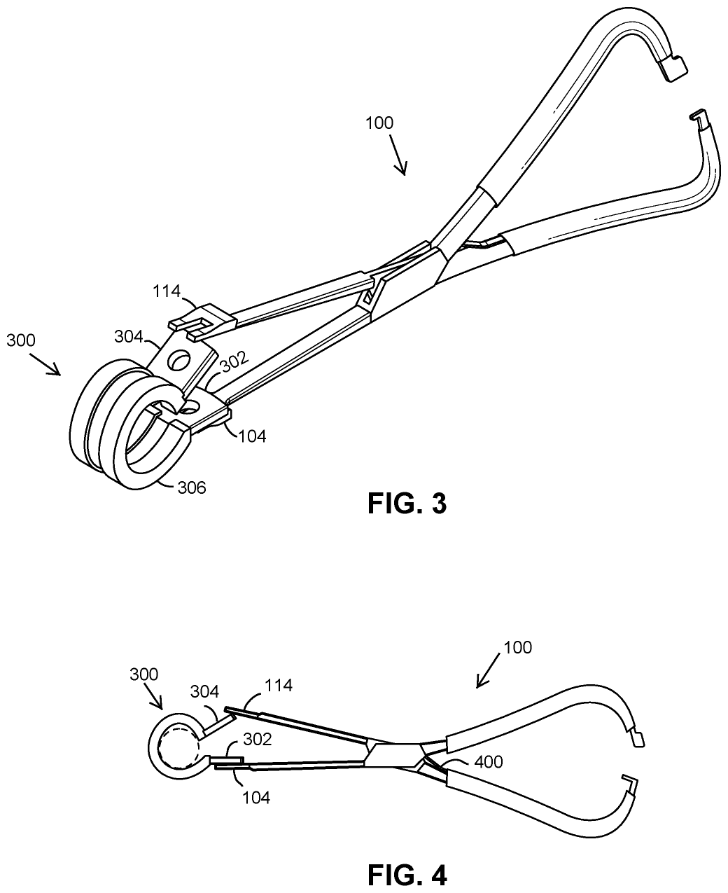

Referring to FIG. 3, an Adel clamp 300 and the bifurcated locking pliers 100 of FIG. 1 are shown in an open configuration such that the pliers 100 are ready to compress the Adel clamp 300. The Adel clamp 300 is a shaped metal band made from aluminum, corrosion-resistant steel, or low-carbon steel, covered by a rubber lining made from silicone. The pliers 100 are here positioned such that both the first bifurcated grasping portion 104 and the second bifurcated grasping portion 114 make compressing contact with the ends 302 and 304, respectively, of the Adel clamp 300.

With reference to FIG. 4, a side view is shown of the bifurcated locking pliers 100 of FIG. 3 in the open configuration, positioned so as to be ready to compress the Adel clamp 300, such that the first bifurcated grasping portion 104 presses against the end 302 of the Adel clamp 300, and the second bifurcated grasping portion 114 presses against the end 304 of the Adel clamp. FIG. 4 also shows an optional leaf spring 400 that is of the form of a slender arc-shaped length of spring steel of rectangular cross-section. The leaf spring 400 provides resilient resistance to closing the pliers 100, and provides an opening force when the pliers 100 are closed, and while the pliers 100 are allowed to open.

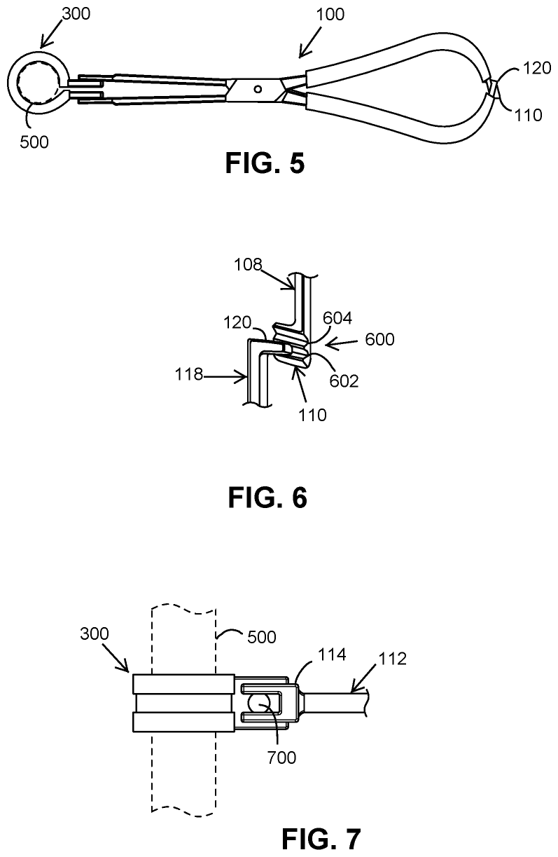

Referring to FIG. 5, a side view is shown of the bifurcated locking pliers 100 of FIG. 4, now in a closed and locked configuration so as to maintain the Adel clamp 300 in a compressed configuration about a generic cylinder 500 (shown in dotted line).

With reference to FIG. 6, a rear view is presented of the locking mechanism 600 of the bifurcated locking pliers 100 of FIG. 5, the locking mechanism 600 including a wedged projection 120 at the end of the second handle 118 that can be captured in one of a series 110 of ridges 602, 604 along the end of the first handle 108 of the locking pliers 100. As the pliers 100 are closed, one of the ridges 602, 604 engages with the wedged projection 120 so as to keep the bifurcated grasping portions 104, 114 from separating.

Referring to FIG. 7, a top view is shown of the bifurcated grasping portion 114 of the second plier arm 112 of the locking pliers 100 of FIG. 5, shown in a closed configuration for maintaining the Adel clamp 300 in a compressed condition around the generic cylinder 500, the Adel clamp 300 having a screw hole 700, and the bifurcated grasping portion 114 providing access to the screw hole 700 while the Adel clamp 300 is compressed by the bifurcated grasping portion 114. Note that each bifurcated grasping portion 104, 114 includes a slot having a width configured to surround the screw hole 700, and to therefore accommodate a screw.

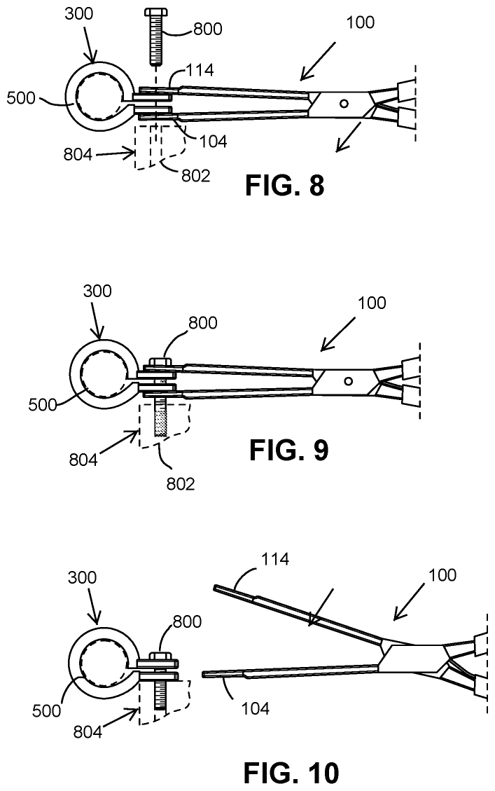

Referring to FIG. 8, a side view is presented of the locking pliers 100 shown in a closed configuration for maintaining the Adel clamp 300 in a compressed condition around the generic cylindrical object 500. The screw hole 700 of the Adel clamp 300 is about to receive a screw 800, while the bifurcated grasping portions 114 and 104 maintain the Adel clamp 300 in a compressed configuration around the cylinder 500. Optionally, an awl (not shown) can be inserted in the screw holes 700 of the Adel clamp 300 so as to align the holes 700 before inserting the screw 800. Further, the awl can be used to align the holes 700 with the hole 802 of the mounting block 804 so as to enable the screw 800 to secure the Adel clamp 300 to the mounting block 804, while also maintaining the Adel clamp 300 in a tightly closed condition.

Referring to FIG. 9, just before finally tightening the screw 800 that is maintaining the Adel clamp 300 in an almost closed condition, the locking mechanism 600 of the pliers 100 can be disengaged, and the pliers 100 can be opened so that the bifurcated grasping portions 114 and 104 of the pliers 100 can be withdrawn from the Adel clamp 300.

Referring to FIG. 10, the screw 800 can then be fully tightened so as to effectively secure the Adel clamp 300 to the mounting block 804, while the Adel clamp 300 is also secured to the cylinder 500. The pliers 100 are now in an open position and are free to move away from the Adel clamp 300.

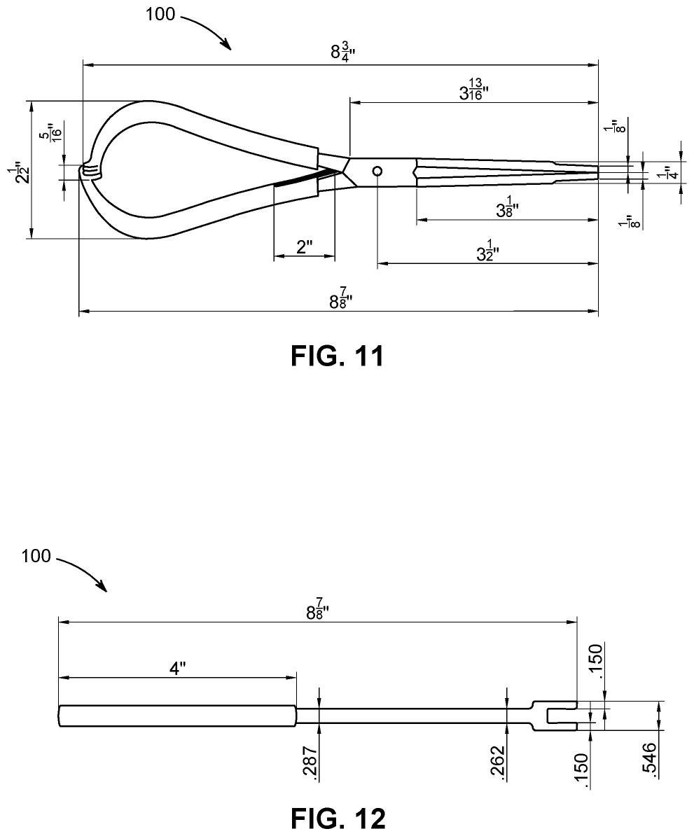

Referring to FIG. 11, a side view is shown of the bifurcated locking pliers 100 of FIG. 4 in a closed and locked configuration, the bifurcated grasping portions of the pliers are shown without an Adel clamp, also showing some exemplary dimensions of various portions of the bifurcated locking pliers 100.

Referring to FIG. 12, a top view is provided of the bifurcated locking pliers 100 of FIG. 11, showing some more exemplary dimensions of various portions of the bifurcated locking pliers 100.

Other modifications and implementations will occur to those skilled in the art without departing from the spirit and the scope of the invention as claimed. Accordingly, the above description is not intended to limit the invention, except as indicated in the following claims.

What is claimed is:

1. A locking pliers for enhanced control of Adel clamps during installation, inspection, and removal of such clamps, the locking pliers comprising:
a first plier arm including:
a first bifurcated grasping portion;
a first pivot portion;
a first handle portion extending from the first pivot portion, the first handle portion ending in a series of ridges; and
a second plier arm including:
a second bifurcated grasping portion;
a second pivot portion pivotably connected to the first pivot portion;
a second handle portion extending from the second pivot portion, the second handle portion ending in a wedge, the wedge being cooperative with the series of ridges so as to serve as an adjustable locking mechanism.

2. The locking pliers of claim 1, wherein the handle portion is coated with cushioning grip material.

3. The locking pliers of claim 2, wherein the cushioning grip material is made from: rubber or silicone.

4. The locking pliers of claim 1, wherein the first and second bifurcated grasping surfaces have smoothed edges.

5. The locking pliers of claim 1, further comprising:
a leaf spring configured to resiliently resist bringing the first handle portion and the second handle portion together.

6. The locking pliers of claim 1, wherein the first plier arm and the second plier arm are made from high-carbon steel.

7. The locking pliers of claim 1, wherein the first plier arm and the second plier arm are of equal length, the length being within a range of: 8″ to 12″.

8. The locking pliers of claim 1, wherein the first bifurcated grasping portion and the second bifurcated grasping portion exhibit mirror symmetry.

9. The locking pliers of claim 1, wherein each bifurcated grasping portion includes a slot having a width configured to accommodate a screw.

10. The locking pliers of claim 1, wherein the first handle portion has an arcuate shape, and the second handle portion has an arcuate shape.

11. A locking pliers for enhanced control of Adel clamps during installation, inspection, and removal of such clamps, the locking pliers comprising:
a first plier arm including:
a first bifurcated grasping portion having a slot of a width configured to accommodate a screw;
a first pivot portion;
a first handle portion extending from the first pivot portion, the first handle portion ending in a series of ridges, the first handle portion coated with cushioning grip material;
a second plier arm including:
a second bifurcated grasping portion having a slot of a width configured to accommodate a screw;
a second pivot portion pivotably connected to the first pivot portion;
a second handle portion extending from the second pivot portion, the second handle portion ending in a wedge, the wedge being cooperative with the series of ridges so as to serve as an adjustable locking mechanism, the second handle portion coated with cushioning grip material; and
a leaf spring configured to resiliently resist bringing the first handle portion and the second handle portion together.

12. The locking pliers of claim 11, wherein the cushioning grip material is made from: rubber or silicone.

13. The locking pliers of claim 11, wherein the first and second bifurcated grasping surfaces have smoothed edges.

14. The locking pliers of claim 11, wherein the first plier arm and the second plier arm are made from high-carbon steel.

15. The locking pliers of claim 11, wherein the first plier arm and the second plier arm are of equal length, the length being within a range of: 8″ to 12″.

16. The locking pliers of claim 11, wherein the first bifurcated grasping portion and the second bifurcated grasping portion exhibit mirror symmetry.

17. The locking pliers of claim 11, wherein the first handle portion has an arcuate shape, and the second handle portion has an arcuate shape.
